(19) United States
(12) Patent Application Publication
(10) Pub. No.: US 2024/0394031 A1
(43) Pub. Date: Nov. 28, 2024

(54) DEPLOYMENT FOR COMPLEX ORCHESTRATION

(71) Applicant: MICROSOFT TECHNOLOGY LICENSING, LLC, Redmond, WA (US)

(72) Inventors: Peter Louis WHITE, Edinburgh (GB); Calum Sutherland LOUDON, Edinburgh (GB); Olga ARKHANGELSKAIA, Enfield (GB)

(21) Appl. No.: 18/202,840

(22) Filed: May 26, 2023

(51) Int. Cl. G06F 8/65; G06F 9/455

(52) U.S. Cl. CPC G06F 8/65; G06F 9/45533

(57) ABSTRACT

Techniques are described for updating a service component implemented in a virtualized computing network configured in a user-specific configuration. The service component executes in a plurality of virtual machines or containers managed by an orchestrator The updating is performed by an update component configured to execute a series of operations in the virtualized computing network that coordinate an upgrade of the service component.

### BACKGROUND

Service providers can provide computing services to businesses and individuals as a remote computing service or provide “software as a service” (e.g., cloud computing). When deploying resources, such as virtualized resources, in a complex computing environment, various issues may arise, resulting in deployment delays which in turn can prevent users from providing services to their downstream users. This can lead to lost revenue and customer dissatisfaction. Production loss and inefficiencies with respect to computing resources can be exacerbated when configuration issues arise and the service provider is unable to quickly isolate and correct the cause of a misconfiguration issue.

It is with respect to these considerations and others that the disclosure made herein is presented.

### SUMMARY

When new or updated deployments involve a large number of resources, such as multiple virtual network functions and various software versions, a series of operations with intermediate steps may need to be defined and executed. The system as a whole needs to be steered through a more complex path rather than independently updating a discrete set of components. The disclosed embodiments describe techniques for using a compiler and a mapping layer to generate sequences of intermediate configuration steps based on declarative statements. The compiler and mapping layer are configured to receive intent-based user inputs that simplify how the user expresses a desired outcome. For example, an operator can express the intent to move from state A to state B for a given function or deployment. The underlying configuration may require that in order to update the system from state A to state B, a series of intermediate steps C, D, E need to be executed, resulting in an overall sequence of A, C, D, E, B. The disclosed compiler and mapping layer generate the intermediate steps C, D, E and alleviates the operator from having to know about or specify the mandated intermediate steps C, D, E. The disclosed mechanism further identifies incompatible state transitions or when it is not possible to transition directly between states and use rules to get from the start state to end state. The disclosed compiler and mapping layer are data-driven and maintain a declarative paradigm. The mapping layer may also be referred to herein as a mapping component.

The described techniques can allow for a service provider or customer to more efficiently update and deploy computing resources while maintaining efficient use of computing capacity such as processor cycles, memory, network bandwidth, and power.

This Summary is provided to introduce a selection of concepts in a simplified form that are further described below in the Detailed Description. This Summary is not intended to limit the scope of the claimed subject matter.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example architecture in accordance with the present disclosure;

FIG. 2 is a diagram illustrating an example architecture in accordance with the present disclosure;

FIG. 3 is a diagram illustrating an example architecture in accordance with the present disclosure:

FIG. 4 is a flowchart depicting an example procedure for managing computing resources in accordance with the present disclosure:

FIG. 5 is an example computing system in accordance with the present disclosure.

### DETAILED DESCRIPTION

Achieving a stable deployment which is robust, efficient and secure is often challenging. In some cases, containerized or virtualized applications are used to facilitate deployments of applications in the cloud. A container is a standalone, executable package of software that includes various components needed to run an application. Deploying containerized applications simplifies the deployment process since once a container is added to a web server or other cloud computing node, that node has everything needed to execute the application. Technologies used to develop containerized applications are often referred to as cloud-native technologies since they are designed to create software suitable for deploying to the cloud. Containerized applications are often deployed by decomposing the application into a plurality of microservices and deploying the microservices separately. A microservice is a single function module with a well-defined interface that is independently deployable and operable.

Deploying or updating an application in the cloud as a cloud service is not straightforward because of the many factors that need to be taken into account. Many services provided by cloud service providers are implemented in the context of a microservices architecture. Such cloud-based architectures rely on the platform/infrastructure to coordinate and manage upgrades of software across a large pool of virtual machines/containers providing that service. For containers, many services are built around Kubernetes for providing such processes. However, there is no easy way to efficiently perform the update process. For example, upgrading a virtualized network function (VNF) may involve upgrading various VNFCs, each of which may comprise a pool of VNFC instances (VNFCIs) or virtual machines (VMs). Furthermore, multiple configuration issues and version compatibilities must be verified.

The disclosed embodiments describe techniques for using a compiler and a mapping layer to generate sequences of intermediate configuration steps based on declarative statements in order to execute an update to a cloud-based infrastructure. The compiler and mapping layer are configured to receive intent-based user inputs that simplify how the user expresses a desired outcome for an update. The present disclosure describes techniques for complex deployments that provide for declarative inputs. Rather than imperative inputs that focus on describing a sequence of steps or instructions to perform a task, declarative inputs focus on describing the desired result or outcome without explicitly specifying how to achieve the desired result or outcome. The present disclosure allows for large scale changes to be made declaratively rather than imperatively. In an example, if an instance of a service is running at version 1 and an instance is running at version 1 and another instance running at version 2, when the instance that is version 2 is in active use, version 1 will need to be removed in some scenarios and not in others. Thus, there are different steps that need to be applied, for possibly multiple sites, and thus complexity increases from having to maintain and account for such differences.

The use of a declarative input or a series of declarative inputs provides operators the ability to deploy changes to a system with fewer steps and without having to identify details regarding intermediate steps. Additionally, the need to generate large amounts of code to control an update or deployment is avoided. The changes or updates may be for virtual machines, containers, and various services and functions that are implemented in the cloud system. More generally, the changes or updates can be made to service components that generally refer to functions implemented by components such as virtual machines or containers.

The present disclosure describes compiler and a mapping layer that allows an operator to declaratively execute an update or deployment without specifying specific underlying operations by codifying the mapping of the declarative statements. The compiler and mapping layer receives declarative statements that indicate that a system is to be modified from state A to state B, and generates rules for how the system is to be modified from state A to state B. The intermediate states can include other parameters including any required waiting periods. The intermediate states are automatically updated if additional information is provided to the compiler and mapping layer. In many cases a complicated set of intermediate steps is sometimes needed in order to make a change in a parameter. The compiler and mapping layer allows operators to avoid having to track and implement changes to the intermediate steps for all possible cases and for every possible pair of versions. The compiler and mapping layer generates all the intermediate steps.

In an embodiment, the compiler and mapping layer are configured to receive as inputs a minimum set of fields or values that are needed in order for the intermediate states to be automatically generated.

While the examples herein are described with reference to containers and virtual machines, it should be understood that other embodiments may include other types of resources and components while implementing the described techniques. Additionally, the disclosed embodiments may be applied to performance of upgrades of clusters across multiple cloud deployments.

In some embodiments, the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

Referring to the appended drawings, in which like numerals represent like elements throughout the several FIGURES, aspects of various technologies for remote management of computing resources will be described. In the following detailed description, references are made to the accompanying drawings that form a part hereof, and which are shown by way of illustration specific configurations or examples. While many examples are described using servers and disks, it should be understood that other types of compute nodes and storage devices may be used in other embodiments.

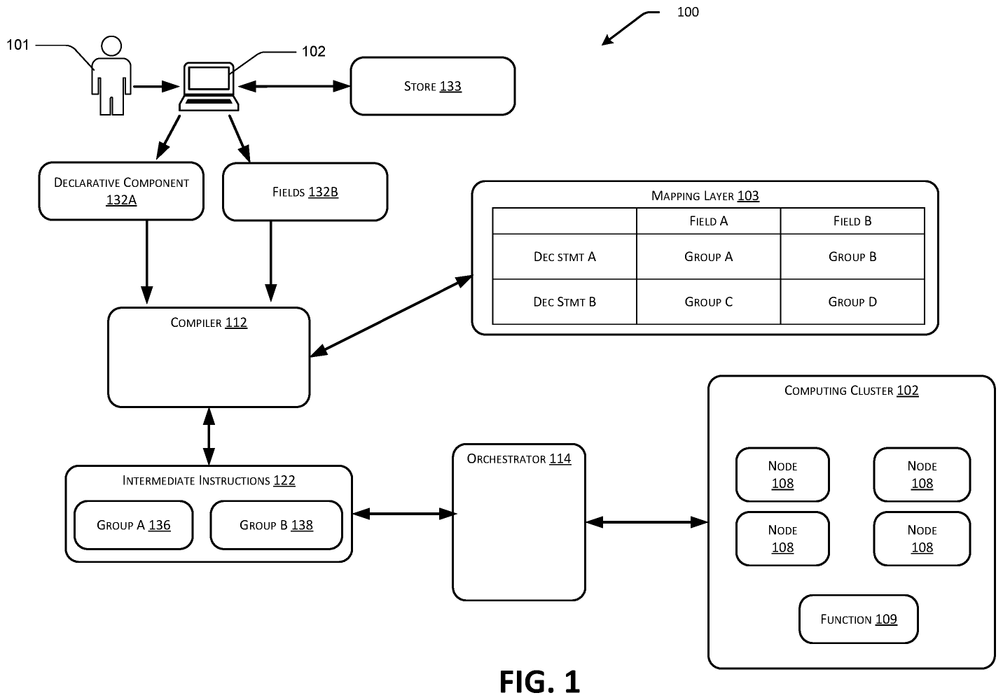

FIG. 1 illustrates a compiler 112 and mapping layer 103 for generating intermediate instructions 122 based on a declarative component 132A and fields 132B in a cloud network 100. The intermediate instructions 122 can include multiple sets of instructions such as group A 136 and group B 138. The intermediate instructions 122 are input to an orchestrator 114 of a computing cluster 102 of nodes 108 in order to deploy or modify a function 109 in the cluster 102. The declarative component 132A along with fields 132B defines a deployment or update of the function 109 and significant benefits are achieved in accordance with the disclosed embodiments, including efficiency and accuracy of function deployment as explained in more detail below.

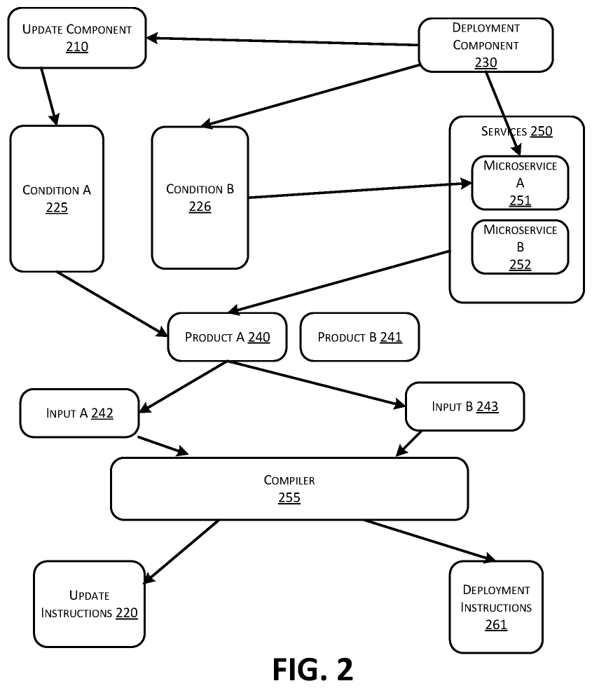

An intermediate instruction 122 can include one or more statements in a standardized format that is readable by orchestrators, management tools, etc. For example, the intermediate instructions 122 can be written in a markup language. In some embodiments the intermediate instructions 122 can be a software component, for example having an interface for receiving messages and sending responses. An intermediate instruction 122 can have one or more expressions which have concrete values and/or a reference to another intermediate instruction 122. The intermediate instruction 122 also has a mapping as explained in more detail with reference to FIG. 2. A store 133 of declarative statements is optionally available. In some cases the declarative statements in the store 133 have associated version numbers.

An operator 101 using a computer 102 enters a declarative statement in computer 102 which outputs a declarative component 132A which defines a deployment or update of a function which it is desired to deploy in the computing cluster 102 of nodes. The operator 101 enters the declarative statement manually and optionally by including in the declarative statement references to one or more other declarative statements from store 102. The operator 101 is provided the option to include references within declarative statements to other declarative statements in order to create more complex declarative statements.

The compiler 112, with mapping layer 103, compiles the declarative component 132A into intermediate instructions 122 which are suitable for input to an orchestrator 112. In an example the intermediate instructions 122 are in the form of Helm charts although any cloud native intermediate instructions are usable. An orchestrator 114 is a management node of the computing cluster 102. The orchestrator 114 has an interface to receive intermediate instructions 122 and deploy an application in the computing cluster 102 according to the instructions. In an example the orchestrator 114 is implemented using Kubernetes; however any software for automating computer application deployment, scaling, and management is used to implement the orchestrator 114. In an example, the intermediate instructions 122 are provided in a programming language, such as Helm or another cloud native language. The compiler 112 and mapping layer 103 are configured to receive declarative components 132A and fields 132B and interpret the declarative components 132A and fields 132B to generate and output the intermediate instructions 122. In an embodiment, the intermediate instructions 122 can include multiple groups of intermediate instructions such as group A 136 and group B 138.

The compiler 112 and mapping layer 103 include functionality that uses a data-driven model to generate the intermediate instructions based on the declarative statements, fields, network and configuration data, and other information. In an embodiment, the network and configuration data, and other information can be specific to a particular target computing environment where an update is to be deployed. The target computing environment can be a data center, a portion of a data center, a region, or any logical or geographic zone comprising computing resources. In an embodiment, the data-driven model matches intermediate instructions to the declarative statements, fields, network and configuration data, and other information using a classifier and can include one or more tables or other data structures. In an embodiment, the classifier searches a set of table entries until a match is found for a particular combination of declarative statements, fields, network and configuration data, and other information, in which case a set of one or more intermediate instructions which are associated with the match are applied to the particular combination. If no match is found, the particular combination can be allocated to a default action, such as return an indication that the input is not valid. The compiler 112 and mapping layer 103 can also perform a consistency check to verify that the particular combination of declarative statements, fields, network and configuration data, and other information include valid entries or that there are otherwise no conflicting inputs.

Once the intermediate instructions 122 are received at the orchestrator 112 the orchestrator executes the intermediate instructions 122 in order to deploy or update the function 109 in the computing cluster 102. In some embodiments, the operator can enter a revision to the declarative statements, fields, network and configuration data, and other information after the execution of the intermediate instructions 122. The intermediate instructions can be updated to effect the revision. After the deployment or update is completed, the updated or deployed function 109 is available as a service to one or more client devices that use or access services provided by cloud network 100.

The declarative component 132A may have one or more dependencies as explained with reference to FIG. 2 below. In various examples the compiler 112 can implement dependency resolution, dependency tracking, and dependency updating. The compiler 100 of the disclosure operates to achieve efficiency and accuracy of application deployment and updates. The compiler 112 improves the functioning of the underlying computer system by enabling declarative statements to be used to deploy and update functions in cloud environments.

In an embodiment, a change to the user-specific configuration can be detected. The compiler 112 or other component can detect the change. In response to detecting the change to the user-specific configuration, the update can be paused, and the intermediate instructions to effect the update in the virtualized computing network can be updated. The updated intermediate instructions can then be executed to continue the update.

Using declarative statements means that there is no need to specifically define how to deploy an update for each user environment. Additionally, the validity of an individual declarative statement can be confirmed when it is entered by the operator, and confidence can be carried into the next stage of deployment. The disclosed embodiments enable a range of functional upgrades or deployments that can be customized to particular needs at a much greater rate, and with vastly increased confidence of quality, as compared to producing the same application deployment outcome with existing technology. Using the disclosed compiler, an operator is able to define the desired cloud operations in a well typed manner, avoiding maintainability issues of writing detailed instructions such as Helm charts. Benefits are achieved because the declarative statements can be compiled into forms suitable for different types of orchestrators. In this way the declarative statements can be implemented in different environments and reused even where the orchestrator is different from an orchestrator previously used with the declarative statement.

In an embodiment, a declarative statement has optional concrete values referred to as fields for deployment, which can include expressions which have concrete values. In an embodiment, a declarative statement can be mapped to software comprising expressions and including an interface.

When declarative statements are input by an operator and stored in store 102 of FIG. 1, the appropriate mappings are determined by mapping layer 103 to enable determination of mappings to intermediate instructions.

FIG. 2 shows a component defining a deployment of update component 210 and deployment component 230 which enter a compile and mapping process to generate intermediate instructions referred to as update instructions 220 and deployment instructions 261 in FIG. 2 which are examples of intermediate instructions 122 of FIG. 1. The component defining update component 210 and deployment component 230 in FIG. 2 are examples of declarative component 132A of FIG. 1. The declarative statements for update component 210 define a first graph of intermediate instructions and declarative statements for deployment component 230 define a second graph of intermediate instructions. In the example of FIG. 2 the component defining update component 210 references other information such as condition A 225 which in turn references product A 240. The component defining deployment component 230 references other information such as condition B 226 which in turn references microservice A 251 of services 250 which in turn references product A 240. Product B 241 and microservice B 252 are not referred to in this example.

Thus FIG. 2 shows two graphs which have shared sub structure. Each graph is made up of components connected by edges where the edges represent references in parent components referring to child components. A first graph is for deploying update component 210 and has update component 210 component as its root node. A second graph is for deploying deployment component 230. The first and second graphs share sub-structure since there are components in common between the graphs. For example, the component referred to as product A 240 is part of the first graph and part of the second graph. In this way it is seen that efficiencies and accuracies in deployment are achieved because of the shared sub-structure. If update component 210 has successfully been deployed, then by re-using the deployment definition for update component 210, it is possible to ensure accuracy of the deployment of update component 210 at least in respect of condition A 225. Efficiencies are also gained since the definition of update component 210 is re-used.

Any of the update components 210 or deployment component 230 can be compiled into intermediate instructions where needed. Each leaf node of a graph represents a component which an atomic unit defined by the compiler 255 where an atomic unit is a component which cannot be subdivided. The graphs of FIG. 2 show dependencies between components. In the example of FIG. 2, input A 242 and input B 243 are both dependent on product A 240.

In an example, a declarative statement can define the scope and target network for an update, such as define scope={s1, s2} and define (function h 4.2) except {(s1.v2, s2.v3)}. These statements can define networks s1 and s2 which are to receive an update to function h to version 4.2, where exceptions are if s1 is at v2, or s2 is at v3. The compiler 112 can generate a set of intermediate representation instructions to achieve the desired update for the identified networks and functions.

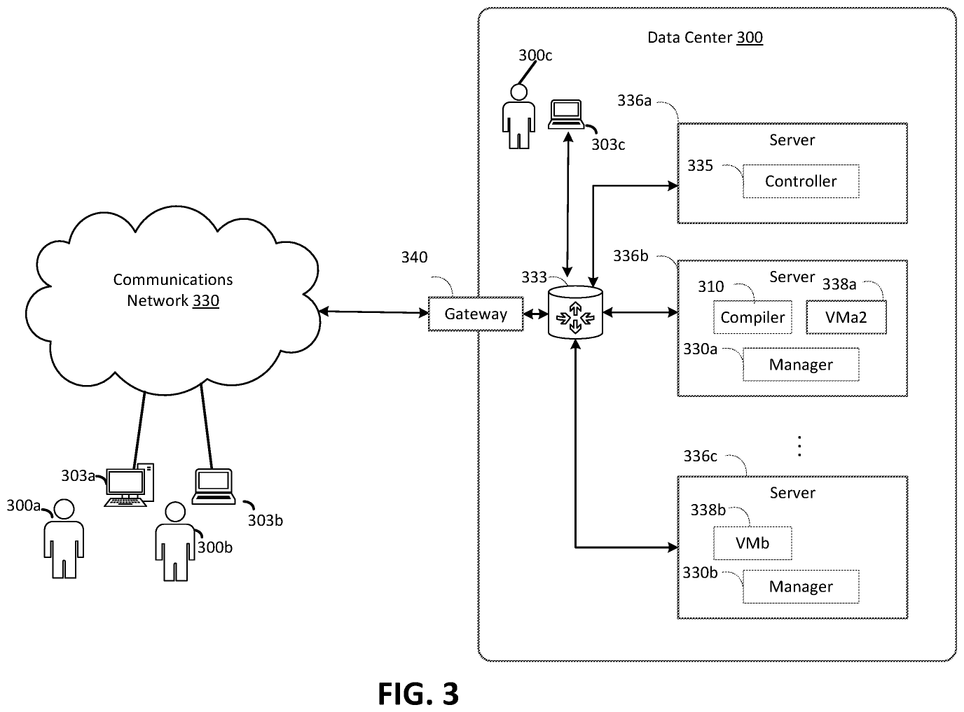

FIG. 3 illustrates an example computing environment in which the embodiments described herein may be implemented. FIG. 3 illustrates a data center 300 that is configured to provide computing resources to users at the customer environment. The customer environment may have user computers that may access services provided by data center 300 via a network 330. The computing resources provided by the data center 300 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like.

Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor). Networking resources may include virtual networking, software load balancer, and the like. The virtual machines may be configured to execute applications, including Web servers, application servers, media servers, database servers, and the like. Data storage resources may include file storage devices, block storage devices, and the like.

Data center 300 may have various computing resources including servers, routers, and other devices that may provide remotely accessible computing and network resources using, for example, virtual machines. Other resources that may be provided include data storage resources. Data center 300 may also execute functions that manage and control allocation of network resources, such as a network manager 330a.

Network 330 may, for example, be a publicly accessible network of linked networks and may be operated by various entities, such as the Internet. In other embodiments, network 330 may be a private network, such as a dedicated network that is wholly or partially inaccessible to the public. Network 330 may provide access to computers and other devices at the customer environment.

The disclosed embodiments may be implemented in a mobile edge computing (MEC) environment implemented in conjunction with a 4G, 5G, or other cellular network. The MEC environment may include at least some of the components and functionality described in FIG. 1 above. Additionally, components of a 5G network may include network functions such as a Session Management Function (SMF), Policy Control Function (PCF), and N7 interface. A radio access network (RAN) may comprise 5G-capable UEs, a base station gNodeB that communicates with an Access and Mobility Management Function (AMF) in a 5G Core (5GC) network. The 5G network may further comprise a User Plane Function (UPF) and Policy Charging Function (PCF).

It should be appreciated that although the embodiments disclosed above are discussed in the context of virtual machines, other types of implementations can be utilized with the concepts and technologies disclosed herein. It should be also appreciated that the network topology illustrated in FIG. 3 has been greatly simplified and that many more networks and networking devices may be utilized to interconnect the various computing systems disclosed herein. These network topologies and devices should be apparent to those skilled in the art.

FIG. 3 illustrates that computing resources are provided to users 300a, 300b, or 300c (which may be referred herein singularly as “a user 300” or in the plural as “the users 300”) via user computers 303a,303b, and 303c (which may be referred herein singularly as “a computer 303” or in the plural as “the computers 303”) via communications network 330.

Data center 300 may include servers 336a, 334, and 336c (which may be referred to herein singularly as “a server 336” or in the plural as “the servers 336”) that may be standalone or installed in server racks, and provide computing resources available as virtual machines 338a and 338b (which may be referred to herein singularly as “a virtual machine 338” or in the plural as “the virtual machines 338”). The virtual machines 338 may be configured to execute applications such as Web servers, application servers, media servers, database servers, and the like. Other resources that may be provided include data storage resources (not shown on FIG. 3) and may include file storage devices, block storage devices, and the like. Servers 336 may also execute functions that manage and control allocation of resources in the data center, such as a controller 335. Controller 335 may be a fabric controller or another type of program configured to manage the allocation of virtual machines on servers 336.

In an embodiment, a compiler 310 as described herein may be implemented in server 334. The compiler 310 may include a mapping layer as further described herein (not shown in FIG. 3).

Referring to FIG. 3, communications network 330 may, for example, be a publicly accessible network of linked networks and may be operated by various entities, such as the Internet. In other embodiments, communications network 330 may be a private network, such as a corporate network that is wholly or partially inaccessible to the public.

Communications network 330 may provide access to computers 303. Computers 303 may be computers utilized by users 300. Computer 303a, 303b or 303c may be a server, a desktop or laptop personal computer, a tablet computer, a smartphone, a set-top box, or any other computing device capable of accessing data center 300. User computer 303a or 303b may connect directly to the Internet (e.g., via a cable modem). User computer 303c may be internal to the data center 300 and may connect directly to the resources in the data center 300 via internal networks. Although only three user computers 303a,303b, and 303c are depicted, it should be appreciated that there may be multiple user computers.

Computers 303 may also be utilized to configure aspects of the computing resources provided by data center 300. For example, data center 300 may provide a Web interface through which aspects of its operation may be configured through the use of a Web browser application program executing on user computer 303. Alternatively, a stand-alone application program executing on user computer 303 may be used to access an application programming interface (API) exposed by data center 300 for performing the configuration operations.

Servers 336 may be configured to provide the computing resources described above. One or more of the servers 336 may be configured to execute a manager 330a or 330b (which may be referred herein singularly as “a manager 330” or in the plural as “the managers 330”) configured to execute the virtual machines. The managers 330 may be a virtual machine monitor (VMM), fabric controller, or another type of program configured to enable the execution of virtual machines 338 on servers 336, for example.

It should be appreciated that although the embodiments disclosed above are discussed in the context of virtual machines, other types of implementations can be utilized with the concepts and technologies disclosed herein.

In the example data center 300 shown in FIG. 3, a network device 333 may be utilized to interconnect the servers 336a and 334. Network device 333 may comprise one or more switches, routers, or other network devices. Network device 333 may also be connected to gateway 340, which is connected to communications network 330. Network device 333 may facilitate communications within networks in data center 300, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that data center 300 described in FIG. 3 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

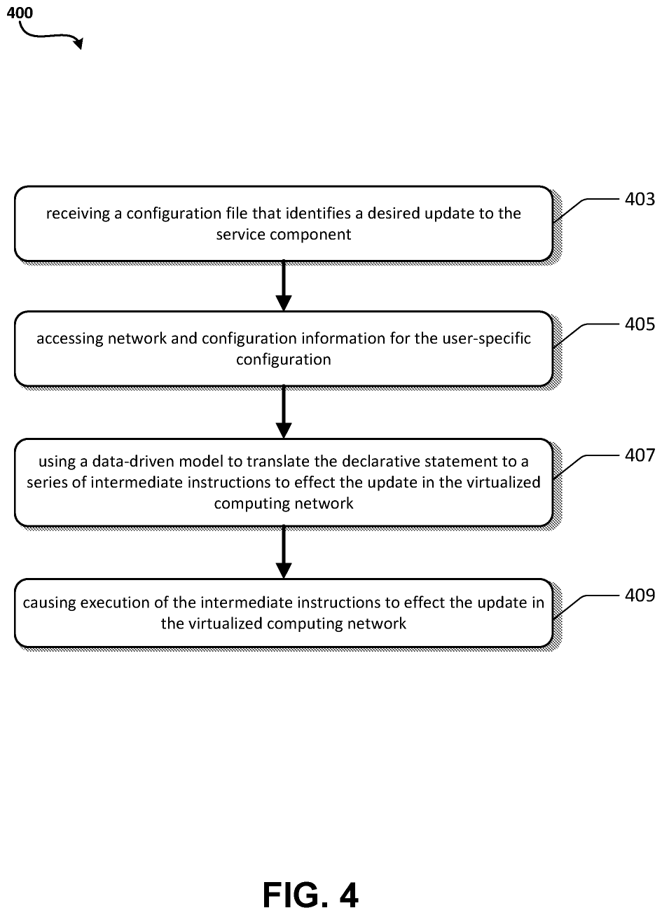

Turning now to FIG. 4, illustrated is an example operational procedure for updating a virtualized network function (VNF) implemented in a virtualized computing network configured in a user-specific configuration. In an embodiment, the VNF executes in a plurality of virtual machines or containers managed by an orchestrator. In an embodiment, the updating is performed by an update component configured to execute a series of operations in the virtualized computing network that coordinate an upgrade of the VNF. Such an operational procedure can be provided by one or more components illustrated in FIGS. 1 through 3. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 400 is described as running on a system, it can be appreciated that the routine 400 and other operations described herein can be executed on an individual computing device or several devices.

Referring to FIG. 4, operation 403 illustrates receiving a configuration file that identifies a desired update to the service component. In an embodiment, the configuration file includes a declarative statement indicating a goal state and a set of fields indicating configuration data for the user-specific configuration.

Operation 405 illustrates accessing network and configuration information for the user-specific configuration.

Operation 407 illustrates based on the configuration file and the network and configuration data, using a data-driven model to translate the declarative statement to a series of intermediate instructions to effect the update in the virtualized computing network.

Operation 409 illustrates causing execution of the intermediate instructions to effect the update in the virtualized computing network.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like: b) a case in which at least some tasks are implemented in soft (configurable) FPGA logic or the like: c) a case in which at least some tasks run as software on FPGA software processor overlays or the like: d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

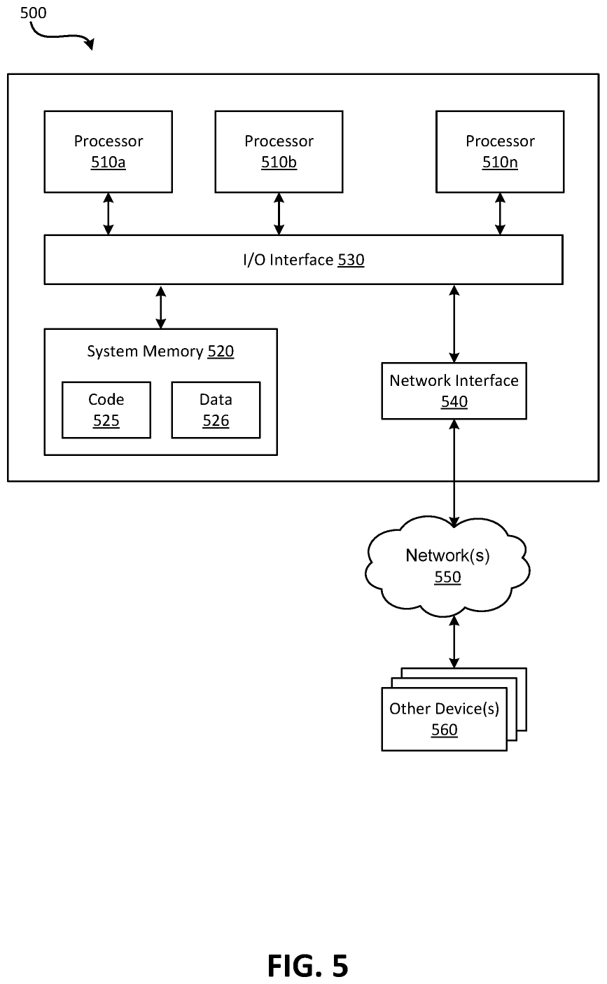

FIG. 5 illustrates a general-purpose computing device 500. In the illustrated embodiment, computing device 500 includes one or more processors 510a, 510b, and/or 510n (which may be referred herein singularly as “a processor 510” or in the plural as “the processors 510”) coupled to a system memory 520 via an input/output (I/O) interface 530. Computing device 500 further includes a network interface 540 coupled to I/O interface 530.

In various embodiments, computing device 500 may be a uniprocessor system including one processor 510 or a multiprocessor system including several processors 510 (e.g., two, four, eight, or another suitable number). Processors 510 may be any suitable processors capable of executing instructions. For example, in various embodiments, processors 510 may be general-purpose or embedded processors implementing any of a variety of instruction set architectures (ISAs), such as the x55, PowerPC, SPARC, or MIPS ISAs, or any other suitable ISA. In multiprocessor systems, each of processors 510 may commonly, but not necessarily, implement the same ISA.

System memory 520 may be configured to store instructions and data accessible by processor(s) 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 520 as code 525 and data 526.

In one embodiment, I/O interface 530 may be configured to coordinate I/O traffic between the processor 510, system memory 520, and any peripheral devices in the device, including network interface 540 or other peripheral interfaces. In some embodiments, I/O interface 530 may perform any necessary protocol, timing, or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components. Also, in some embodiments some or all of the functionality of I/O interface 530, such as an interface to system memory 520, may be incorporated directly into processor 510.

Network interface 540 may be configured to allow data to be exchanged between computing device 500 and other device or devices 560 attached to a network or network(s) 550, such as other computer systems or devices as illustrated in FIGS. 1 through 5, for example. In various embodiments, network interface 540 may support communication via any suitable wired or wireless general data networks, such as types of Ethernet networks, for example. Additionally, network interface 540 may support communication via telecommunications/telephony networks such as analog voice networks or digital fiber communications networks, via storage area networks such as Fibre Channel SANs or via any other suitable type of network and/or protocol.

In some embodiments, system memory 520 may be one embodiment of a computer-accessible medium configured to store program instructions and data as described above for FIGS. 1-4 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 500 via I/O interface 530. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 500 as system memory 520 or another type of memory. Further, a computer-accessible medium may include transmission media or signals such as electrical, electromagnetic or digital signals, conveyed via a communication medium such as a network and/or a wireless link, such as may be implemented via network interface 540. Portions or all of multiple computing devices, such as those illustrated in FIG. 5, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 5, may include other components that are not explicitly shown in FIG. 5, or may utilize an architecture completely different than that shown in FIG. 5.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms: furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. The disclosure presented herein also encompasses the subject matter set forth in the following clauses:

Clause 1: A method for updating a service component implemented in a virtualized computing network configured in a user-specific configuration, the service component executing in a plurality of virtual machines or containers managed by an orchestrator, the updating performed by an update component configured to execute a series of operations in the virtualized computing network that coordinate an upgrade of the service component, the method comprising:
receiving a configuration file that identifies a desired update to the service component, the configuration file including a declarative statement indicating a goal state and a set of fields indicating configuration data for the user-specific configuration;
accessing network and configuration information for the user-specific configuration;
based on the configuration file and the network and configuration data, using a data-driven model to translate the declarative statement to a series of intermediate instructions to effect the update in the virtualized computing network; and causing execution of the intermediate instructions to effect the update in the virtualized computing network.

Clause 2: The method of clause 1, further comprising:
detecting a change to the user-specific configuration;
in response to detecting the change to the user-specific configuration, pausing the update in the virtualized computing network;
based on the change to the user-specific configuration, updating the intermediate instructions to effect the update in the virtualized computing network; and causing execution of the updated intermediate instructions.

Clause 3: The method of any of clauses 1-2, wherein the intermediate instructions are abstracted from underlying details of the user-specific configuration of the virtualized computing network.

Clause 4: The method of any of clauses 1-3, wherein the update component includes a mapping component configured to translate the declarative statement to the intermediate instructions.

Clause 5: The method of any of clauses 1-4, further comprising performing a consistency check of the virtual machines or containers prior to effecting the update.

Clause 6: The method of any of clauses 1-5, further comprising performing a consistency check of the virtual machines or containers subsequent to effecting the update.

Clause 7: The method of clauses 1-6, wherein the translating the declarative statement comprises resolving dependencies between the declarative statement and resources in the virtualized computing network.

Clause 8: The method of any of clauses 1-7, further comprising in response to receiving a revision to the declarative statement, updating the intermediate instructions to effect the revision.

Clause 9: The method of any of clauses 1-8, wherein the revision is received after some of the intermediate instructions have been executed.

Clause 10: A system comprising:
one or more processors; and
a memory in communication with the one or more processors, the memory having computer-readable instructions stored thereupon that, when executed by the one or more processors, cause the system to perform operations comprising:
receiving a configuration file that identifies an update to a service component implemented in a target computing environment configured in a user-specific configuration, the service component executing in a plurality of virtual machines or containers managed by an orchestrator, the update performed by an update component configured to execute a series of operations in the target computing environment that coordinate an update of the service component, the configuration file including a declarative statement indicating a goal state and a set of fields indicating configuration data for the user-specific configuration;
based on the configuration file, translating the declarative statement to a series of intermediate instructions to effect the update in the virtualized computing network; and
causing execution of the intermediate instructions to effect the update in the virtualized computing network.

Clause 11: The system of clause 10, wherein the target computing environment is a virtualized computing network.

Clause 12: The system of any of clauses 10 and 11, wherein the intermediate instructions are abstracted from underlying details of the user-specific configuration of the virtualized computing network.

Clause 13: The system of any clauses 10-12, wherein the update component includes a mapping component configured to translate the declarative statement to the intermediate instructions.

Clause 14: The system of any clauses 10-13, further comprising computer-readable instructions stored thereupon that, when executed by the one or more processors, cause the system to perform operations comprising performing a consistency check of the virtual machines or containers prior to effecting the update.

Clause 15: The system of any clauses 10-14, wherein the translating the declarative statement comprises resolving dependencies between the declarative statement and resources in the virtualized computing network.

Clause 16: The system of any clauses 10-15, further comprising computer-readable instructions stored thereupon that, when executed by the one or more processors, cause the system to perform operations comprising in response to receiving a revision to the declarative statement, updating the intermediate instructions to effect the revision.

Clause 17: The system of any clauses 10-16, wherein the revision is received after some of the intermediate instructions have been executed.

Clause 18: A computer-readable storage medium having computer-executable instructions stored thereupon which, when executed by one or more processors of a system, cause the system to perform operations comprising:
receiving a configuration file that identifies an update to a service component implemented in a target computing environment configured in a user-specific configuration, the service component executing in a plurality of virtual machines or containers managed by an orchestrator, the update performed by an update component configured to execute a series of operations in the target computing environment that coordinate an update of the service component, the configuration file including a declarative statement indicating a goal state and a set of fields indicating configuration data for the user-specific configuration;
based on the configuration file, translating the declarative statement to a series of intermediate instructions to effect the update in the virtualized computing network; and
causing execution of the intermediate instructions to effect the update in the virtualized computing network.

Clause 19: The computer-readable storage medium of clause 18, wherein the intermediate instructions are abstracted from underlying details of the user-specific configuration of the virtualized computing network.

Clause 20: The computer-readable storage medium of any of clauses 18 and 19, wherein the update component includes a mapping component configured to translate the declarative statement to the intermediate instructions.

1. A method for updating a service component implemented in a virtualized computing network configured in a user-specific configuration, the service component executing in a plurality of virtual machines or containers managed by an orchestrator, the updating performed by an update component configured to execute a series of operations in the virtualized computing network that coordinate an upgrade of the service component, the method comprising:
receiving a configuration file that identifies a desired update to the service component, the configuration file including a declarative statement indicating a goal state and a set of fields indicating configuration data for the user-specific configuration;
accessing network and configuration information for the user-specific configuration;
based on the configuration file and the network and configuration data, using a data-driven model to translate the declarative statement to a series of intermediate instructions to effect the update in the virtualized computing network; and
causing execution of the intermediate instructions to effect the update in the virtualized computing network.

2. The method of claim 1, further comprising:
detecting a change to the user-specific configuration;
in response to detecting the change to the user-specific configuration, pausing the update in the virtualized computing network;
based on the change to the user-specific configuration, updating the intermediate instructions to effect the update in the virtualized computing network; and
causing execution of the updated intermediate instructions.

3. The method of claim 1, wherein the intermediate instructions are abstracted from underlying details of the user-specific configuration of the virtualized computing network.

4. The method of claim 1, wherein the update component includes a mapping component configured to translate the declarative statement to the intermediate instructions.

5. The method of claim 1, further comprising performing a consistency check of the virtual machines or containers prior to effecting the update.

6. The method of claim 1, further comprising performing a consistency check of the virtual machines or containers subsequent to effecting the update.

7. The method of claim 1, wherein the translating the declarative statement comprises resolving dependencies between the declarative statement and resources in the virtualized computing network.

8. The method of claim 1, further comprising in response to receiving a revision to the declarative statement, updating the intermediate instructions to effect the revision.

9. The method of claim 8, wherein the revision is received after some of the intermediate instructions have been executed.

10. A system comprising:
one or more processors; and
a memory in communication with the one or more processors, the memory having computer-readable instructions stored thereupon that, when executed by the one or more processors, cause the system to perform operations comprising:
receiving a configuration file that identifies an update to a service component implemented in a target computing environment configured in a user-specific configuration, the service component executing in a plurality of virtual machines or containers managed by an orchestrator, the update performed by an update component configured to execute a series of operations in the target computing environment that coordinate an update of the service component, the configuration file including a declarative statement indicating a goal state and a set of fields indicating configuration data for the user-specific configuration;
based on the configuration file, translating the declarative statement to a series of intermediate instructions to effect the update in the virtualized computing network; and
causing execution of the intermediate instructions to effect the update in the virtualized computing network.

11. The system of claim 10, wherein the target computing environment is a virtualized computing network.

12. The system of claim 10, wherein the intermediate instructions are abstracted from underlying details of the user-specific configuration of the virtualized computing network.

13. The system of claim 10, wherein the update component includes a mapping component configured to translate the declarative statement to the intermediate instructions.

14. The system of claim 10, further comprising computer-readable instructions stored thereupon that, when executed by the one or more processors, cause the system to perform operations comprising performing a consistency check of the virtual machines or containers prior to effecting the update.

15. The system of claim 10, wherein the translating the declarative statement comprises resolving dependencies between the declarative statement and resources in the virtualized computing network.

16. The system of claim 10, further comprising in response to receiving a revision to the declarative statement, updating the intermediate instructions to effect the revision.

17. The system of claim 16, wherein the revision is received after some of the intermediate instructions have been executed.

18. A computer-readable storage medium having computer-executable instructions stored thereupon which, when executed by one or more processors of a system, cause the system to perform operations comprising:
receiving a configuration file that identifies an update to a service component implemented in a target computing environment configured in a user-specific configuration, the service component executing in a plurality of virtual machines or containers managed by an orchestrator, the update performed by an update component configured to execute a series of operations in the target computing environment that coordinate an update of the service component, the configuration file including a declarative statement indicating a goal state and a set of fields indicating configuration data for the user-specific configuration;
based on the configuration file, translating the declarative statement to a series of intermediate instructions to effect the update in the virtualized computing network; and
causing execution of the intermediate instructions to effect the update in the virtualized computing network.

19. The computer-readable storage medium of claim 18, wherein the intermediate instructions are abstracted from underlying details of the user-specific configuration of the virtualized computing network.

20. The computer-readable storage medium of claim 18, wherein the update component includes a mapping component configured to translate the declarative statement to the intermediate instructions.
